(19) United States
(12) Patent Application Publication
(10) Pub. No.: US 2008/0024028 A1
(43) Pub. Date: Jan. 31, 2008

(54) Permanent magnet electric motor

(76) Inventors: Mohammad S. Islam, Saginaw, MI (US); Paul M. Fisher, Saginaw, MI (US); Tomy Sebastian, Saginaw, MI (US); Ramakrishnan Raja Venkitasubramony, Saginaw, MI (US); Tom C. Wong, Saginaw, MI (US)

Correspondence Address: DELPHI TECHNOLOGIES, INC., M/C 480-410-202, PO BOX 5052, TROY, MI, 48007, US

(21) Appl. No.: 11/494,088

(22) Filed: Jul. 27, 2006

(51) Int. Cl. H02K 21/12; H02K 23/42; H02K 1/00

(52) U.S. Cl. 310/187; 310/216; 310/156.47; 310/156.25

(57) ABSTRACT

An electric motor for reducing torque ripple includes a rotor, a plurality of magnets positioned about the rotor, and a stator including a plurality of stator teeth configured to form at least two slot openings each having a slot opening width wₒ and a slot opening height hₒ. One or more of the stator teeth include a dummy channel having a channel height wₙ and a channel width w_{b}. At least one of the slot opening width wₒ, the slot opening height hₒ, the channel height wₙ, and the channel width w_{b}, are selected so as to minimize or reduce cogging torque.

### TECHNICAL FIELD

This invention relates to torque ripple reduction in electric motors.

### BACKGROUND OF THE INVENTION

Most motor vehicle steering systems produced today employ a power assist steering system to assist the driver in steering the front wheels. In general, power assist steering systems employ a hydraulic pump to provide pressurized fluid to a piston connected to or formed in the steering rack assembly, the pressure being regulated by a valve which is opened or closed by an amount that varies with the torque in the steering column. Thus, as the driver exerts more effort against the steering wheel, the valve is opened to provide more fluid to the piston, thereby assisting the driver in steering the vehicle.

It has been heretofore known to provide a power assist steering system using an electric motor instead of pressurized hydraulic fluid as a source of motive force. This would improve fuel economy and reduce the manufacturing cost of the vehicle. Furthermore, system reliability would be improved since many components including the hydraulic pump and fluid lines can be eliminated.

Perhaps the most vexing issue with electric power assist steering systems has been torque ripple felt at the steering wheel. Torque ripple is a variation in reaction torque felt by the driver as the steering wheel is turned. Drivers accustomed to the smooth response of hydraulic power assist steering systems have reacted unfavorably to the torque ripple exhibited by electric power assist steering systems. This torque ripple is caused by certain design characteristics of the electric motor used to provide the power assist.

In a permanent magnet, brushless electric motor driven by a sinusoidal current, there are two primary sources of torque ripple: cogging torque and harmonic content in line-to-line back emf. Harmonic content is attributable to an imperfect sinusoidal back emf waveform. Cogging torque is caused by magnetic attraction between rotor-mounted permanent magnets and the slotted structure of the stator. The torque created thereby is called cogging torque because it seeks to inhibit motion of the rotor as the rotor passes through some rotational positions, and accelerate motion of the rotor as the rotor passes through other rotational positions.

Cogging torque results from a storage and release of magnetic energy during rotation of the rotor relative to the stator. At certain rotational angles, magnetic energy is stored and, at other rotational angles, this energy is released. When energy is being stored, the rotor is effectively being braked, and additional energy must be applied in order to keep the rotor turning at a substantially constant rate. When energy is being released, the driving force applied to the rotor increases, momentarily driving the rotor at a faster rate. The rotational angles at which energy is stored or released are determined by the respective geometries of the stator and the rotor. As the leading edge of a rotor magnet approaches an individual stator tooth, a positive torque is produced by the force of magnetic attraction exerted therebetween. However, as the leading edge of the magnet passes the tooth and the trailing edge approaches the tooth, a negative torque is produced. Accordingly, individual rotor poles (i.e., so-called pole boundaries) exhibit a tendency to align themselves in the minimum reluctance area in the stator structure.

If the rotor shaft of such a motor is turned by hand, it is possible to feel the effect of every slot. To an observer, it appears as if the pole boundaries of the motor are being attracted by the stator slots, or attempting to stick to these slots. It is useful to conceptualize the magnetic effects which cause cogging torque to be concentrated at the pole boundary.

Various motor design parameters have an effect on cogging torque. For example, the amplitude of cogging torque is affected by slot opening to slot pitch ratio, magnet strength, and air gap length. The instantaneous value of cogging torque varies with rotor position and alternates at a frequency that is proportional to the motor speed, and number of slots and poles.

Since cogging torque is highly disruptive in applications such as electrical power steering assist systems, it would be desirable to select motor design parameters for which cogging torque is minimized or eliminated. One technique for reducing cogging torque is to utilize a stator having a slotless stator. Manufacturing and labor costs are quite expensive, thereby negating much of the benefit of using an electric power assist steering system.

### BRIEF SUMMARY OF THE INVENTION

The previously discussed and other drawbacks are overcome or alleviated by an electric motor for reducing torque ripple. The electric motor includes a rotor, a plurality of magnets positioned about the rotor, and a stator including a plurality of stator teeth configured to form at least two slot openings each having a slot opening width wₒ and a slot opening height hₒ. One or more of the stator teeth include a dummy channel having a channel height wₙ and a channel width w_{b}. At least one of the slot opening width wₒ, the slot opening height hₒ, the channel height wₙ, and the channel width w_{b}, are selected so as to minimize or reduce cogging torque.

In another embodiment, an electric motor for reducing torque ripple includes a rotor and a plurality of magnets positioned about the rotor, so as to provide at least ten magnetic poles. The motor also includes a stator configured to form at least twelve slots. The magnets are skewed with respect to the rotational axis of the motor. Pursuant to a further embodiment, the magnets are skewed by approximately six mechanical degrees.

In another embodiment, a motor for reducing torque ripple includes a stator having t slots, a shaft having a shaft axis, a rotor positioned about the shaft and having p poles, t and p having a least common multiple M, a first magnet ring positioned on the rotor, the first magnet ring comprising magnets each occupying a magnet angle δ on the rotor, and a second magnet ring positioned on the rotor, the second magnet ring comprising magnets each occupying a magnet angle δ on the rotor, wherein the second magnet ring is shifted a non-zero number of degrees relative to the first magnet ring such that an end of each magnet within the second magnet ring is located at a different angular position than an end of each magnet within the first magnet ring relative to the shaft axis. Optionally, discrete arc magnets may be employed instead of, or in addition to, magnet rings.

In another embodiment, a motor for reducing torque ripple includes a shaft having a shaft axis, a rotor positioned about the shaft, and a plurality of magnets positioned about the rotor, each magnet occupying a magnet angle δ on the rotor, wherein the magnet angle δ is an optimal magnet angle for minimizing line to line back emf harmonics.

In another embodiment, a motor for reducing torque ripple includes a rotor having a plurality of magnets positioned thereon, and a stator including a plurality of stator teeth configured to form at least a first set of slot openings and a second set of slot openings, wherein a conductor is wound around the plurality of stator teeth so as to form a winding which spans approximately at least 30 mechanical degrees or 150 electrical degrees. Pursuant to a further embodiment, the motor includes a winding configuration wherein a first conductor carrying a first phase of electrical current is wound through the first set of slot openings and a second conductor carrying a second phase of electrical current is wound through the second set of slot openings, such that the each slot opening in the first set of slot openings is disposed in an alternating arrangement with respect to each slot opening in the second set of slot openings, thereby providing a fault tolerant winding configuration.

The above discussed and other features and advantages of the present invention will be appreciated and understood by those skilled in the art from the following detailed description and drawings.

### BRIEF DESCRIPTION OF THE DRAWINGS

The present invention will now be described, by way of example, with reference to the accompanying drawings, in which:

FIG. 1 shows a portion of a cross-section of a permanent magnet electric motor having surface parallel magnets;

FIG. 2 is an exploded cross-sectional view showing a portion of an illustrative stator for use with the permanent magnet electric motor of FIG. 1;

FIG. 3 shows an exemplary plot of cogging torque;

FIG. 4 shows an exemplary chart showing harmonic content of back emf;

FIG. 5 is an isometric view showing the geometry used to define an angle of magnetic skew on the rotor of FIG. 1;

FIG. 6 shows a side view of the magnets of FIG. 1 skewed with reference to the rotational axis of the rotor;

FIG. 7 shows a side view of the magnets of FIG. 1 illustratively divided into two sections so as to form a stepped rotor;

FIG. 8 sets forth a first illustrative winding configuration for the permanent magnet electric motor of FIG. 1;

FIG. 9 sets forth a second illustrative winding configuration for the permanent magnet electric motor of FIG. 1;

FIG. 10 is a cross-sectional view setting forth an illustrative mechanical configuration for the permanent magnet electric motor of FIG. 1; and

FIG. 11 shows an exemplary electric power assist steering system using the motor of FIG. 1.

### DETAILED DESCRIPTION OF THE PREFERRED EMBODIMENTS

The problem of torque ripple caused by the harmonics content in the line-to-line back-emf due to an imperfect sinusoidal back-emf waveform is identified and discussed in more detail in the commonly-assigned U.S. Pat. No. 6,380,658 issued on Apr. 30, 2002 and incorporated herein by reference in its entirety.

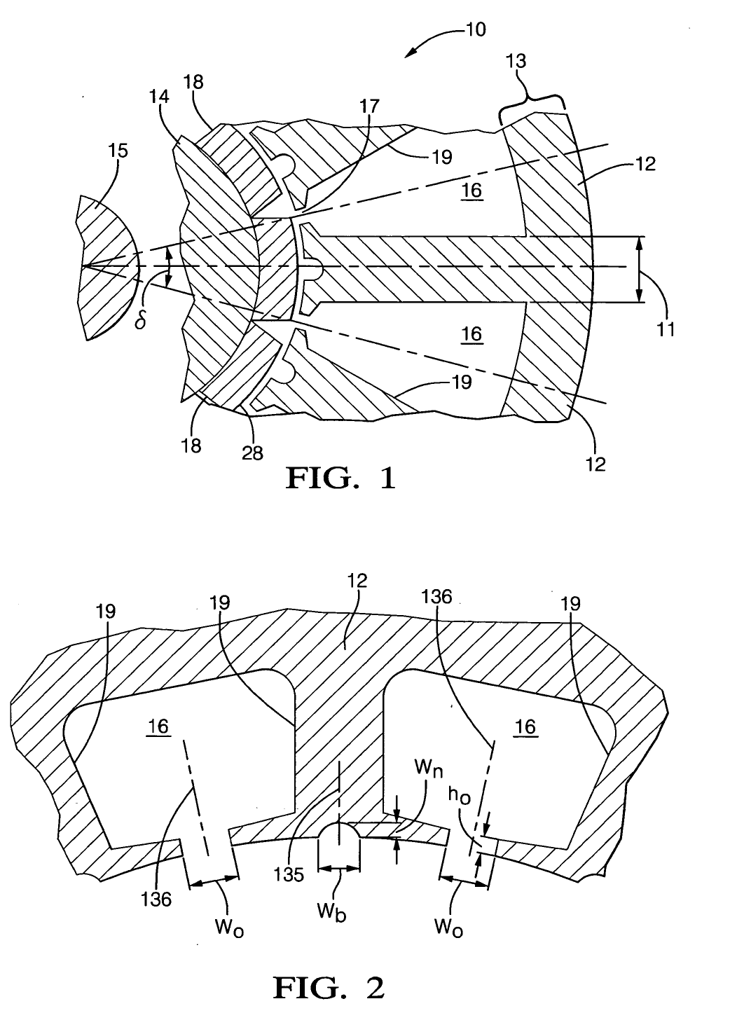

Pursuant to one embodiment of reducing or eliminating cogging torque, a brushless permanent magnet electric motor 10 having surface parallel magnets 18 is shown in FIG. 1. This embodiment provides a cost-effective, high-performance actuator for vehicular applications including electric power steering. Motor 10 includes a stator 12 having disposed therein a rotor 14 mounted to shaft 15. Stator 12 includes a plurality of teeth 19 arranged to form a plurality of slots 16. Windings are formed in the plurality of slots 16 for generating a magnetic field which interacts with the magnetic fields produced by surface parallel magnets 18. In one exemplary embodiment, stator 12 has twelve slots 16 and rotor 14 has ten magnets 18; thus, the slot/pole ratio is 1.2. Magnets 18 may be separated by air spaces 17 equidistantly spaced between the magnets 18. Windings disposed in slots 16 may be provided in a traditional manner as generally known, or fractional pitch windings may be used in conjunction with this invention. For example, the fractional-pitch winding scheme described in commonly-assigned U.S. patent application Ser. No. 09/850,758, which was filed on May 8, 2001 by Buyun Liu et al. and published on Nov. 14, 2002 as Publication No. US2002/0167242 A1, and which is hereby incorporated herein by reference in its entirety, or one similar thereto may be employed.

Each surface-parallel magnet of magnets 18 includes an outer face 28 which delimits an angle δ at the axis of shaft 15. Angle δ will be referred herein as the magnet angle where the angle δ corresponds to the amount of surface area of the rotor 14 that comprises a magnet. In other words, angle δ is the width of a magnet in terms of an electrical angle with reference to a motor shape. As rotor 14 rotates within motor 10, magnets 18 interact with stator 12 due to forces of magnetic attraction and magnetic repulsion, thereby generating what is commonly referred to as cogging torque.

Torque linearity is degraded if stator 12 is in magnetic saturation. In order to enhance torque linearity, a tooth width 11 may be increased, a yoke width 13 may be increased, or both of these dimensions may be increased. Increasing one or both of these dimensions reduces the magnetic flux density in stator 12, consequently reducing the extent of any magnetic saturation present in stator 12, and thereby improving torque linearity.

FIG. 2 is an exploded cross-sectional view showing a portion of an illustrative stator 12 for use with the permanent magnet electric motor of FIG. 1. Stator 12 includes a plurality of slots 16 wherein at least one of a slot opening width wₒ or a slot opening height hₒ is selected so as to reduce cogging torque. A slot pitch is defined as being formed by the centerlines 136 of two adjacent slots 16. Optionally, stator 12 includes one or more dummy channels 130 in one or more teeth of stator teeth 19. Dummy channels 130 reduce the amplitude of cogging torque and, for certain stator 12 configurations, increase the frequency of cogging torque.

The shape and dimensions of dummy channels 130 are selected so as to provide a more symmetrical variation of cogging torque as a function of rotor 14 (FIG. 1) position. More specifically, at least one of channel height wₙ and channel width w_{b} for the dummy channel are selected so as to reduce cogging torque. Although dummy channels 130 are shown in FIG. 2 as having a substantially semicircular or curvilinear cross section, this is for purposes of illustration as other configurations could be adopted for dummy channels 130, including dummy channels with square, rectangular, or trapezoidal cross sectional shapes. Illustratively, each dummy channel is arranged at or near a centerline 135 of teeth 19, although other arrangements are possible, such as providing two or more dummy channels per tooth arranged symmetrically about centerline 135, or providing one or more dummy channels per tooth arranged asymmetrically about centerline 135. In the exemplary configuration of FIG. 2, the curvilinear shape of dummy channels 130 follows that of an arc of a circle having a center on centerline 135, and a diameter larger than or equal to 0.75 wₒ but less than 1.25 wₒ. In addition to reducing cogging torque, this shape increases the durability of the punching die used for manufacturing stator laminations.

Effectively, dummy channels 130 (FIG. 2) provide stator 12 with additional openings beyond those already provided by slots 16. By adding a number (d) of dummy channels 130 at the free ends of each tooth of stator teeth 19, where (d) is an integer greater than or equal to zero, the equivalent number of slots (t) towards the air gap between stator 12 and rotor 14 (FIG. 1) increases from the number of slots that would be present without using dummy channels to ([d+1]t) with dummy channels 130. The frequency of cogging torque is equal to the least common multiple of the number ([d+1]t) of equivalent slot openings and the number of poles (p) provided by magnets 18.

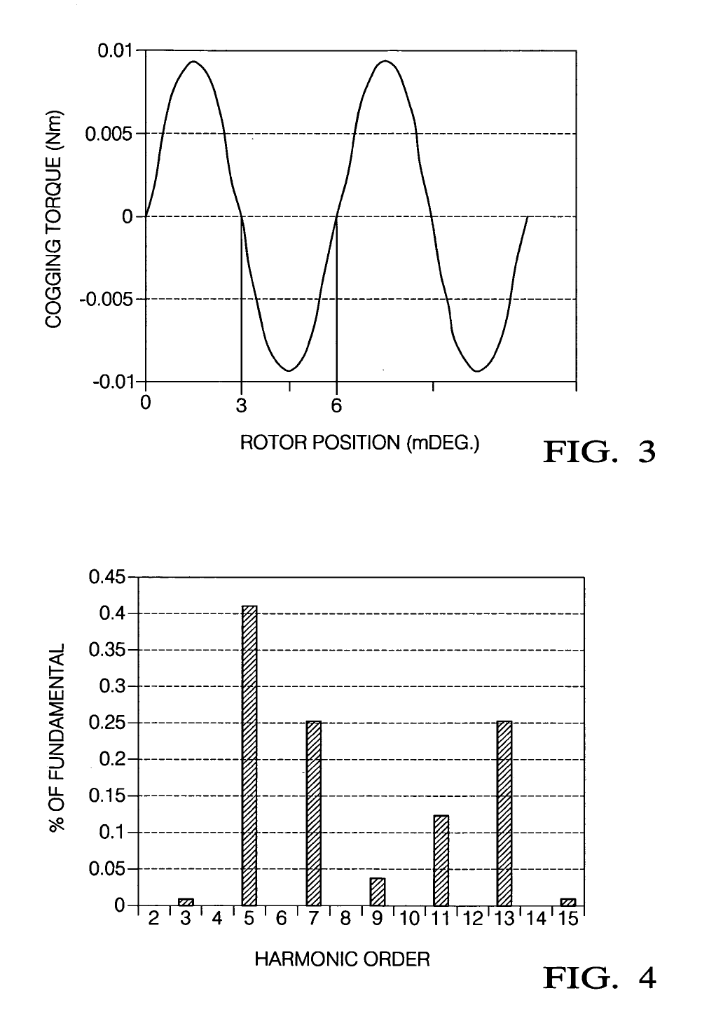

FIG. 3 shows a plot of cogging torque with respect to the rotor position in mechanical degrees (mDeg.) for the motor of FIG. 1 with magnets 18 not having any skew. This plot was generated using finite element analysis. Assuming that positive cogging torque is applied in a clockwise direction and the angles are measured counter-clockwise, or vice versa, it can be seen, as the rotor is rotated from 0 mDeg. to 3 mDeg., the cogging torque is directed against the direction of rotation. As rotor continues from 3 mDeg. to 6 mDeg., the cogging torque is directed in the direction of rotation. Thus, an equilibrium is reached every 6 degrees. The cogging frequency is 60 cycles per mechanical revolution (CPMR), which is the least common multiple of the number of slots (t) and the number of poles (p). The amplitude of the cogging torque is about 19 mN·m, peak-to-peak (along the vertical axis of the graph).

FIG. 4 shows a graph describing the amplitude of the harmonics as a percentage of the fundamental frequency component present in the line-to-line back-emf. The fundamental frequency f for a sinusoidal motor is given by f=Np/120 Hz, where N is the motor speed in rpm and p is the number of rotor poles. Reference is again made to the commonly-assigned U.S. Pat. No. 6,380,658 issued on Apr. 30, 2002, which is incorporated herein by reference, for detailed explanation as to the development of this data. Essentially, it is the result of Fourier analysis on the line-to-line back-emf. In this example, the 5^{th} harmonic content is about 0.4% of the fundamental component. This harmonic content may not be acceptable for applications such as electric power steering. Magnet skewing may be employed to lower the harmonic content in the line to line back-emf, as will be described in greater detail hereinafter.

Analysis shows that a major source of torque ripple, harmonics in the line-to-line back-emf, can be controlled by varying magnet angular width, defined as the angle δ occupied by the outer surface of magnet 18 with reference to rotor 14 (FIG. 1). It is possible to select a magnet angle δ to minimize these back-emf harmonics. For example, as shown by the aforementioned commonly-assigned U.S. Pat. No. 6,380,658, the fifth harmonic component of line-line back emf can be reduced to zero where sin(δn/2)=0°, 180°, 360°, 540°, etc., in electrical angle, where n denotes the harmonic component being reduced to zero. Thus, δ=2(360°)/5=144 eDeg., which correlates to 28.8 mechanical degrees (mdeg) in the 10-pole electric motor of the example shown in FIGS. 1 and 2 (144°/number of pole pairs). Accordingly, the fifth harmonic can be reduced substantially to zero with a magnet angle of δ=28.8 mDeg. Since the 5^{th} and 7th harmonics are the most undesirable terms, the minimization of the 5^{th} and 7th harmonic terms will make the resultant waveform closer to a sine wave.

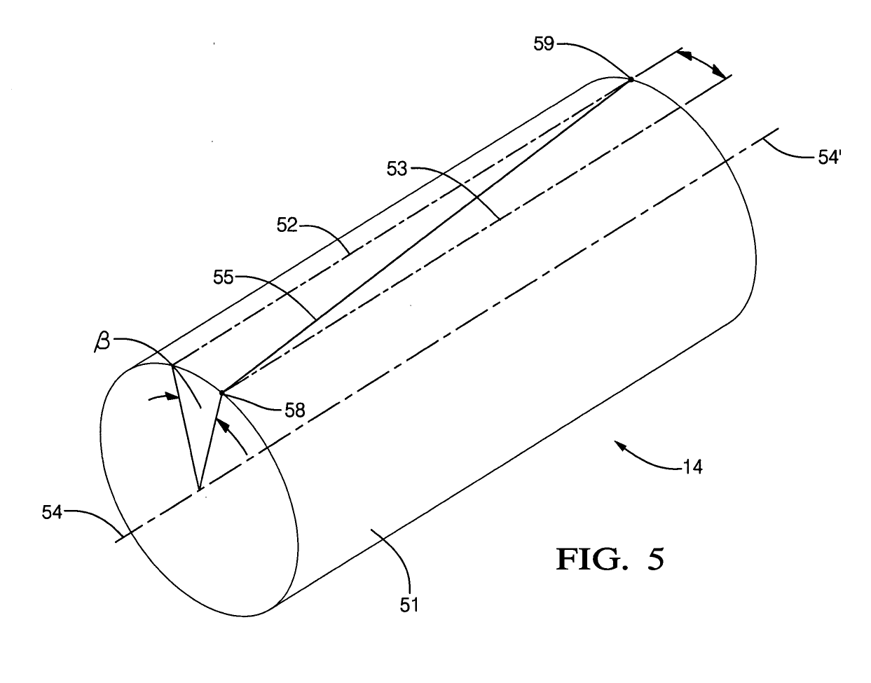

FIG. 5 is an isometric view showing the geometry used to define an angle of magnetic skew on the rotor of FIG. 1. An angle of magnetic skew (β) is defined using an angle formed between a first longitudinal line 52 and a second longitudinal line 53 on an outer surface 51 of rotor 14. Rotor 14 has a central axis of rotation 54 which is parallel to first longitudinal line 52 and second longitudinal line 53. A skew line 55 intersects first longitudinal line 52 at a first point 59. The skew line 55 intersects second longitudinal line 53 at a second point 58. If skewing is not to be utilized, magnets 18 are aligned along first longitudinal line 53 and second longitudinal line 53. However, if magnets 18 are to be skewed, the magnets are aligned along lines running parallel to skew line 55 on outer surface 51 of rotor 14.

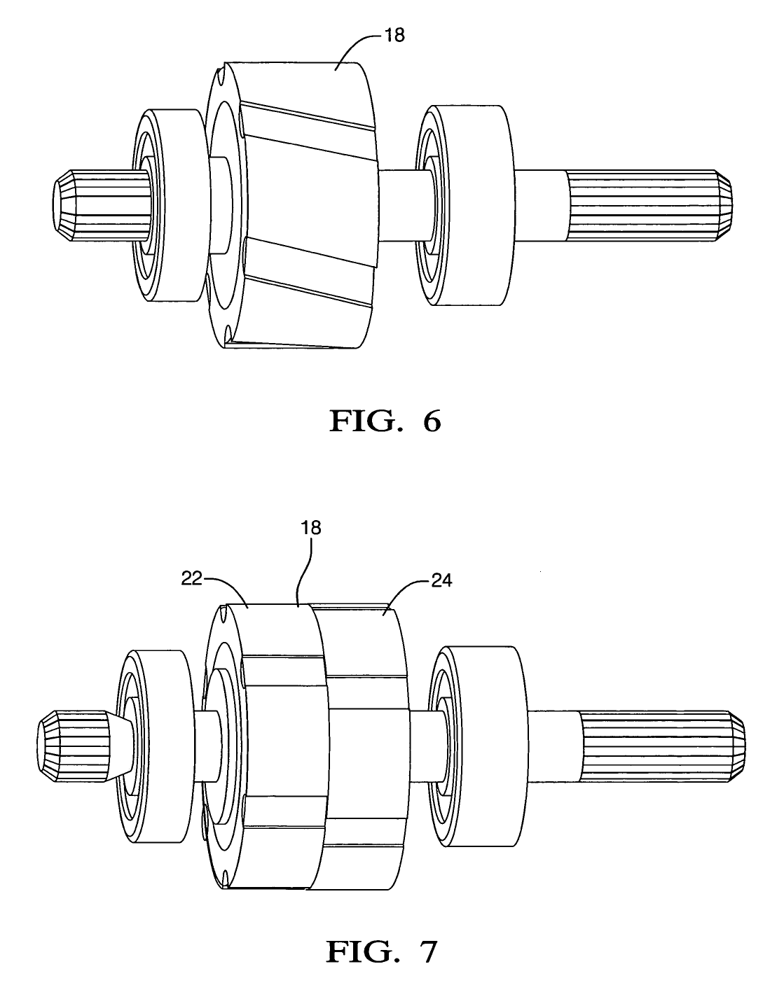

FIG. 6 shows a side view of the magnets of FIG. 1 skewed with reference to the rotational axis of the rotor. By skewing magnets 18 at an angle of magnetic skew (β), cogging torque may be significantly reduced. Recall that, with reference to FIG. 3, the cogging torque cycle has a period of 6 mechanical degrees for a 12-slot, 10-pole motor, resulting in a corresponding cycles per mechanical revolution (CPMR) of 60. In general, the cogging torque cycle has a period in mechanical degrees determined by 360 degrees divided by {the least common multiple of the number of slots (t) and the number of poles (p)}. Accordingly, in order to cancel out this cogging torque, an angle of magnetic skew (β) is selected which is substantially equal to the period in mechanical degrees of the cogging torque cycle.

In the case of a 12-slot, 10-pole motor, the angle of magnetic skew should be approximately 6 mechanical degrees or thirty electrical to cancel out or minimize the cogging torque. Six mechanical degrees is equivalent to ⅕ slot pitch skewing, wherein slot pitch has been defined previously. Reduction in the n^{th} harmonic of line-to-line back emf may be expressed using the equation:

{V_{n, skewed}/V_{n, unskewed}}={[sin(nθ_{skew}/2)]/(nθ_{skew}/2)}, wherein θ_{skew} is in units of electrical radians.

Table I shows the reduction in fundamental and harmonic components for magnets skewed at a ⅕ slot pitch, where slot pitch is 30 mechanical degrees or 150 electrical degrees:

TABLE I

| Skew | First | Fifth | Seventh | Eleventh | Thirteenth |
|---|---|---|---|---|---|
| Angle | Harmonic | Harmonic | Harmonic | Harmonic | Harmonic |
| 0 | 1 | 1 | 1 | 1 | 1 |
| ⅕ | 0.9886 | 0.7379 | 0.5271 | 0.08987 | −0.07605 |
| slot | | | | | |
| pitch | | | | | |

Slight variations in the geometries of magnets 18 or dislocation of one or more of these magnets results in a higher amplitude and lower CPMR of cogging torque. If these variations are of sufficient magnitude, the CPMR of the cogging torque may be equal to the number of slots, i.e., for the exemplary 12-slot motor shown in FIGS. 1 and 2, the cogging torque will be 12 cycles per mechanical revolution (CPMR). Under these circumstances, the cogging torque cannot be minimized by setting the angle of magnetic skew (β) as described above in connection with FIG. 6, which only serves to minimize the 60-CPMR component of cogging torque.

FIG. 7 shows a side view of the magnets of FIG. 1 illustratively divided into two sections so as to form a stepped rotor. To eliminate the 12-CPMR component of cogging torque which occurs due to manufacturing variations, each magnet of magnets 18 (FIG. 1 or FIG. 6) may be segmented into two or more pieces 22, 24 as shown in FIG. 7. Although non-skewed magnets 18 are shown in FIG. 7, those of ordinary skill in the relevant art will appreciate that the segmented pieces 22, 24 may optionally be skewed in a manner similar to that of magnets 18 of FIG. 6. Each piece 22, 24 (FIG. 7) is an integral fraction (i.e., a half, or a third, a fourth, a fifth, etc) of the stack length long in terms of axial length. Each step enables cancellation of one harmonic frequency component, such that one, two, or more steps may be employed. This axial length is substantially equal to an integral fraction of the length of a hypothetical magnet 18 which would be employed in a non-segmented design similar to that of FIG. 6 but without magnet skewing.

In the case of a 12-slot, 10-pole motor, piece 22 is relatively shifted from piece 24 by 3 mechanical degrees. Rotor 14 can thus be viewed as having two sets of magnets 22, 24, each set of magnets consisting of ten poles. Each respective magnet in a first set of magnets is shifted in space by 3 mechanical degrees relative to a corresponding magnet in a second set of magnets to cancel a 60-CPMR component of cogging torque. The axial length of the combined pieces 22, 24 may be substantially equivalent to an axial length of a rotor 14 which is not divided into two pieces. The shift angle depends upon the CPMR component to be cancelled or reduced. In order to cancel or reduce multiple components, multiple steps may be utilized (for example, using a rotor 14 having more than two pieces).

For a step-skewed motor, 2 sets of magnets are shifted by θₛₛ degrees to reduce cogging torque. The effect of this step-skew on harmonic content can be expressed as:

{V_{n, step-skewed}/V_{n, unskewed}}={cos(nθₛₛ/2)}, wherein θₛₛ is an electrical angle.

Table II shows the reduction in fundamental and harmonic components for magnets skewed at a 1/10 slot pitch, where slot pitch is 30 mechanical degrees or 150 electrical degrees:

TABLE II

| Skew | First | Fifth | Seventh | Eleventh | Thirteenth |
|---|---|---|---|---|---|
| Angle | Harmonic | Harmonic | Harmonic | Harmonic | Harmonic |
| 0 | 1 | 1 | 1 | 1 | 1 |
| 1/10 | 0.9914 | 0.7933 | 0.6087 | 0.1305 | −0.1305 |
| slot | | | | | |
| pitch | | | | | |

From an optimization standpoint, ⅕ slot pitch (i.e., 0.2 slot pitch) is selected for skewed rotor magnets (FIG. 6), and 1/10 slot pitch is selected for step-skewed rotor magnets (FIG. 7). This 0.2 slot pitch is the equivalent of 30 electrical degrees, as may be determined using the equation ((10/2)*0.2*(360/12)). The foregoing slot pitch values are optimized for reduction of cogging torque and reduction of odd-harmonic components in line-to-line back emf, while at the same time maximizing the fundamental component representing output torque. If it is not necessary to maximize the fundamental component, slot pitch values above 0.2 may be employed for skewed motor designs, or slot pitch values above 0.1 may be employed for step-skewed motor designs.

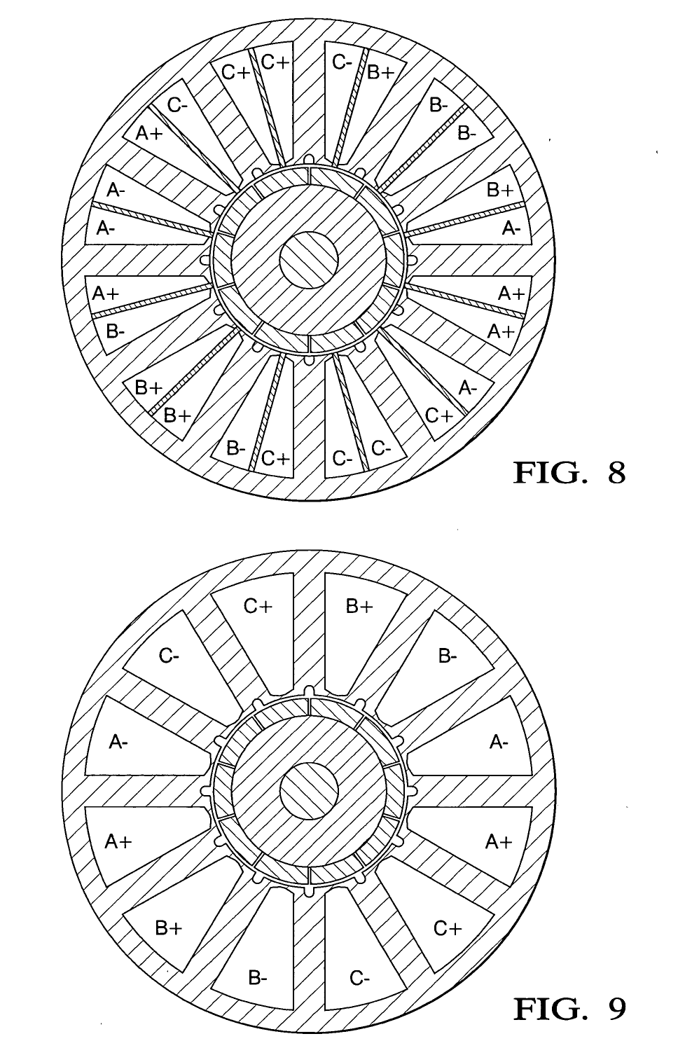

FIG. 8 sets forth a first illustrative winding configuration for the permanent magnet electric motor of FIG. 1. The motor employs concentrated, around-the-tooth windings, thereby providing manufacturing advantages over distributed windings. Consider the concentrated winding configurations used in 3-slot, 4-pole, 6-slot, 4-pole, 9-slot, 6-pole, and 18-slot, 12-pole motor designs. In each of these designs, the coil windings span 120 electrical degrees, thus causing undesirably high harmonic components in line-to-line back emf. More specifically, such a coil span generates undesirably high levels of fifth and seventh order harmonics.

For a 12-slot, 10-pole design, several different winding configurations are possible. Each of these winding configurations provides a different harmonic content. If the coil windings are configured to span 150 degrees (360/12*10/12), this brings about advantages in terms of reducing harmonic content and maximizing winding factors. The theoretical angle span for canceling fifth-order harmonics is 144 degrees, and the theoretical angle span for canceling seventh order harmonics is 154.28 degrees. Accordingly, a winding configuration that spans approximately 150 degrees will provide a reduced level of fifth and seventh order harmonics relative to winding configurations that span smaller or larger angles.

Unbalanced pull originates from nonsymmetrical distribution of the ampere conductors or winding configuration around the periphery of stator 12 (FIG. 1). This unbalanced radial pull contributes to acoustic noise. To achieve low acoustic noise, the windings should be distributed such that each phase maintains a substantially symmetrical current distribution. In the winding configuration of FIG. 8, three different phases are denoted as A, B, and C. For each of these phases, the winding sense may be positive (+) for current flowing in an inward direction perpendicular to the plane of FIG. 8, or negative (−) for current flowing in an outward direction perpendicular to the plane of FIG. 8, thus yielding windings for A+, A−, B+, B−, C+, and C− phases.

In addition to minimizing or eliminating unbalanced pull, the winding configuration of FIG. 8 is advantageous in that 50% of the windings are immune to phase-to-phase short circuits inside a slot. The total harmonic distortion (THD) of voltage induced in the windings is less than 0.3%. Moreover, it is possible to connect the windings either in series or in parallel connections. These windings may be configured to form machines with six, twelve, eighteen, or other multiples of six phases.

FIG. 9 sets forth a second illustrative winding configuration for the permanent magnet electric motor of FIG. 1. The motor employs concentrated, around-the-tooth windings, thereby providing manufacturing advantages over distributed windings. Every alternate tooth carries a winding. There is a symmetrical distribution of ampere conductors winding around stator 12 (FIG. 1). As described previously in connection with FIG. 8, the configuration of FIG. 9 does not provide unbalanced pull. Since the slot is occupied by conductors from only one phase, this winding configuration is immune to faults caused by phase-to-phase short circuits. The THD of the induced voltage is less than 0.6%. Series-parallel winding and multiphase connections are possible, as discussed above.

As a general design consideration applicable to FIGS. 8 and 9, in order to meet the requirements of specific system applications, the motor can be designed to balance electrical loading and magnetic loading. Higher electrical loading (more number of turns per coil) can be avoided to minimize phase resistance and inductance, thereby achieving a desired torque speed objective.

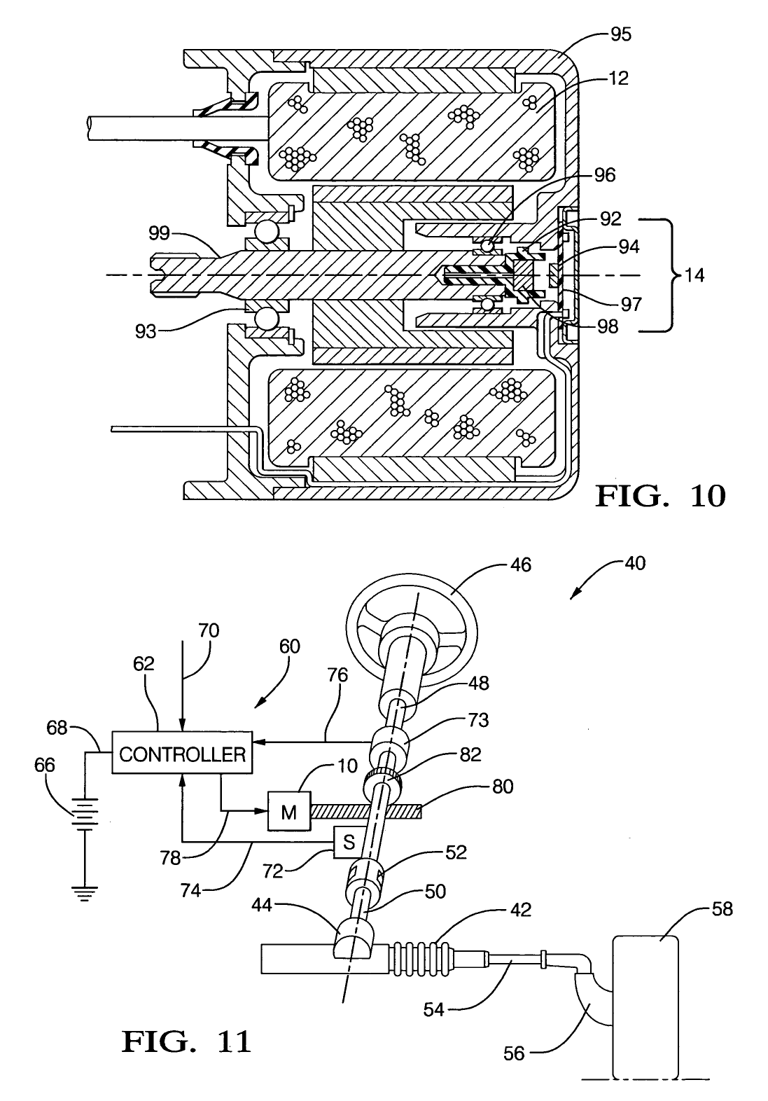

FIG. 10 is a cross-sectional view setting forth an illustrative mechanical configuration for the permanent magnet electric motor of FIG. 1. This configuration may be utilized to reduce the overall physical size of the motor. A rotor 14 having a partially hollow rotor core is used for housing a bearing 96, a motor position sensor 94, as well as a portion of housing 95. The end turn reduction of the motor and housing 95 helps to reduce the axial length of the motor. An adapter 92 holding a puck magnet 98 is buried into a shaft 99. A circuit board 97 accommodates a magnetic field sensing element, such as a Hall sensor or magnetoresistive (MR) element, for sensing the magnetic field produced by puck magnet 98. The positions of circuit board 97 and puck magnet 98 were selected to minimize crosstalk between the motor magnet and an end turn magnetic field. Appropriate magnetic shielding may be employed to minimize the crosstalk further. By adopting this design approach, the physical length of the motor is reduced relative to prior art designs.

The motor designed according to any of various embodiments disclosed herein is useful where smooth power without any discernable torque ripple is desired. One such application is in an electrical power steering system. Referring now to FIG. 11, reference numeral 40 generally designates a motor vehicle power steering system employing motor 10. The steering mechanism 42 is a rack-and-pinion type system and includes a toothed rack (not shown) and a pinion gear (also not shown) located under gear housing 44. As a steering wheel 46 is turned, the upper steering shaft 48, connected to the lower steering shaft 50 through universal joint 52, turns the pinion gear. Rotation of the pinion gear moves the toothed rack, which moves tie rods 54 (only one shown), that in turn move the steering knuckles 56 (only one shown), which turn wheels 58 (only one shown).

Electric power steering assist is provided through the unit generally designated by reference numeral 60, and including a controller 62 and motor 10. Controller 62 is powered by a vehicle power supply 66 through line 68. Controller 62 receives a signal representative of the vehicle velocity on line 70. Steering pinion gear angle is measured through position sensor 72, which may be an optical encoding type sensor, variable resistance type sensor or any other suitable type of position sensor, and fed to controller 62 through line 74.

As steering wheel 46 is turned, torque sensor 73 senses the torque applied to steering wheel 46 by the vehicle operator. Torque sensor 73 may include a torsion bar (not shown) and a variable resistive-type sensor (also not shown) which outputs a variable resistance signal to controller 62 through line 76 in relation to the amount of twist on the torsion bar. Although this is the preferable torque sensor, any other suitable torque-sensing device used with known signal processing techniques are contemplated.

In response to the inputs on lines 70, 74, and 76, controller 62 sends a current command or a voltage command through line 78 to motor 10. Motor 10 supplies torque assist to the steering system through a worm 80 and a worm gear 82, in such a way as to providing a torque assist to the vehicle steering in addition to a driving force exerted by the vehicle operator.

Note that any torque ripple generated by motor 10 would be felt at steering wheel 46. In this environment, motor 10 designed and manufactured according to any of the techniques described previously, will preferably generate torque ripple below humanly perceptible levels.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Terms used herein such as first, second, etc. are not intended to imply an order in space or importance, but are merely intended to distinguish between two like elements.

What is claimed is:

1. An electric motor for reducing torque ripple comprising:
a rotor,
a plurality of magnets positioned about the rotor, and
a stator including a plurality of stator teeth configured to form at least two slot openings each having a slot opening width wₒ and a slot opening height hₒ,
wherein one or more of the stator teeth include a dummy channel having a channel height wₙ and a channel width w_{b}, and
wherein at least one of the slot opening width wₒ, the slot opening height hₒ, the channel height wₙ, and the channel width w_{b}, are selected so as to minimize or reduce cogging torque.

2. The electric motor of claim 1 wherein the plurality of magnets are surface parallel magnets.

3. An electric motor for reducing torque ripple comprising:
a rotor,
a plurality of magnets positioned about the rotor so as to provide at least ten magnetic poles, and
a stator configured to form at least twelve slots;
wherein the magnets are skewed with respect to the rotational axis of the motor.

4. The electric motor of claim 3 wherein the magnets are skewed with respect to the rotational axis of the motor by approximately six mechanical degrees.

5. The electric motor of claim 4 wherein the plurality of magnets are surface parallel magnets.

6. The electric motor of claim 4 wherein the rotor is divided into a first portion and a second portion, the first portion including rotor magnets that are skewed at a first angle with respect to the rotational axis of the rotor, and the second portion including rotor magnets that are skewed at a second angle with respect to the rotational axis of the rotor.

7. The electric motor of claim 6 wherein the first angle is approximately three mechanical degrees.

8. The electric motor of claim 7 wherein the second angle is substantially equal to the first angle.

9. An electric motor for reducing torque ripple including a stator having t slots, a shaft having a shaft axis, a rotor positioned about the shaft and having p poles, t and p having a least common multiple M, a first magnet ring positioned on the rotor, the first magnet ring comprising magnets each occupying a magnet angle δ on the rotor, and a second magnet ring positioned on the rotor, the second magnet ring comprising magnets each occupying a magnet angle δ on the rotor, wherein the second magnet ring is shifted a non-zero number of degrees relative to the first magnet ring such that an end of each magnet within the second magnet ring is located at a different angular position than an end of each magnet within the first magnet ring relative to the shaft axis.

10. The electric motor of claim 9 wherein the first and second magnet rings are each skewed to form a skew angle φ with respect to the shaft axis, the skew angle φ being substantially equal to M divided by p divided by two.

11. The electric motor of claim 9 wherein the first and second magnet rings are each skewed to form a skew angle φ with respect to the shaft axis, the skew angle φ being substantially equal to 360 degrees divided by t.

12. The electric motor of claim 9 wherein the first magnet ring and the second magnet ring contain an equal number of magnets.

13. The electric motor of claim 9 wherein the plurality of magnets are surface parallel magnets.

14. An electric motor for reducing torque ripple including a stator having t slots, a shaft having a shaft axis, a rotor positioned about the shaft and having p poles, t and p having a least common multiple M, a magnet ring positioned on the rotor, the magnet ring comprising magnets each occupying a magnet angle δ on the rotor, wherein the magnet angle δ is selected to minimize one or more harmonic components in line to line back emf.

15. The electric motor of claim 14 wherein the magnet angle δ is selected to minimize fifth order harmonic components in line to line back emf

16. The electric motor of claim 14 wherein the magnet angle δ is selected to minimize seventh order harmonic components in line to line back emf.

17. An electric motor for reducing torque ripple including:
a rotor having a plurality of magnets positioned thereon, and
a stator including a plurality of stator teeth configured to form at least a first set of slot openings and a second set of slot openings, wherein a conductor is wound around the plurality of stator teeth so as to form a winding which spans at least 30 mechanical degrees or 150 electrical degrees.

18. The electric motor of claim 17 further comprising a first conductor carrying a first phase of electrical current wound through the first set of slot openings and a second conductor carrying a second phase of electrical current wound through the second set of slot openings, such that the each slot opening in the first set of slot openings is disposed in an alternating arrangement with respect to each slot opening in the second set of slot openings, thereby providing a fault tolerant winding configuration.

19. The electric motor of claim 17 wherein the plurality of magnets are surface parallel magnets.

20. An electric motor for reducing torque ripple including:
a rotor having a rotor diameter D,
a plurality of magnets positioned on the rotor,
a puck magnet having a diameter d and positioned on the rotor, and
a stator including a plurality of stator teeth configured to form at least a first set of slot openings and a second set of slot openings;
wherein diameter d is less than rotor diameter D.

21. An electric motor for reducing torque ripple including: a rotor having a plurality of magnets positioned thereon, and a stator including a plurality of stator teeth configured to form at least a first set of slot openings and a second set of slot openings, wherein a conductor is wound around the plurality of stator teeth so as to provide a symmetrical distribution of windings with reference to the rotor, thereby reducing or minimizing an unbalanced radial pull of the electric motor.
